(19) United States
(12) Patent Application Publication
(10) Pub. No.: US 2026/0310506 A1
(43) Pub. Date: Oct. 8, 2026

(54) OPTIMIZATION OF RESOURCES ASSOCIATED WITH A COMPUTING SYSTEM

(71) Applicant: GOVERNMENT EMPLOYEES INSURANCE COMPANY (GEICO), Fredericksburg, VA (US)

(72) Inventors: Ashutosh GAIROLA, Bethesda, MD (US); Atul CHHODA, Fairfax, VA (US); Rupesh SHIVARKAR, San Jose, CA (US); Sri Satya Daneswara Rao PAMPANA, Carmel, IN (US); Ramachandra VALLAMSETTY, Chantilly, VA (US); Mansi Bharat KAMDAR, Ashburn, VA (US); James KELLER, Washington, DC (US)

(21) Appl. No.: 19/098,872

(22) Filed: Apr. 2, 2025

(51) Int. Cl. G06F 9/50

(52) U.S. Cl. CPC G06F 9/5027

(57) ABSTRACT

Disclosed herein are system, method, and computer program product embodiments for optimizing resources associated with a computing system. An embodiment operates by retrieving a dataset for a policy framework from a first domain based on an optimization target for the computing system. The dataset may be used to generate a simulation model for the policy framework that is executed in a second domain according to an operational data element associated with the policy framework. The operational data element may correspond to the optimization target. A recommended adjustment to the operational data element may be generated based on an error associated with the optimization target identified during model execution. An instruction that facilitates the recommended adjustment to the operational data element may be sent to the first domain.

### BACKGROUND

Computing systems, including cloud infrastructure, enterprise networks, distributed computing environments, and/or the like, require well-defined policy frameworks to manage resources efficiently. These policy frameworks may include any rules, configurations, parameters, and other similar elements that dictate the operation and behavior of various system components. However, traditional methods for managing and optimizing these policy frameworks are highly manual, prone to errors, and lack predictive capabilities. For example, users (e.g., engineers, system administrators, analysts) often rely on trial-and-error approaches for optimization efforts, which may involve implementing or installing various hardware and software components to evaluate the effects of changes on a policy framework. As a result, computing systems often suffer from inefficiencies, including, but not limited to, overprovisioning of resources, network bottlenecks, security vulnerabilities, and similar issues.

In a similar context, entities that routinely manage large volumes of data (e.g., consumer data, product data, policy data, system data, etc.) to implement various data processes for their operations require well-defined policy frameworks to manage resources efficiently. In this context, policy frameworks may encompass any structure, rules, parameters, or other similar elements that define entity-related products and/or dictate the operation and behavior of various components supporting these products. However, evaluating how changes to different parameters of various policy frameworks affect the operation of the various data processes is a complex and resource-intensive process, which routinely results in failure to optimally provision resources.

### SUMMARY

Provided herein are system, apparatus, device, method, and/or computer program product embodiments, and/or combinations and sub-combinations thereof, for optimization of resources associated with a computing system. A dataset for a policy framework may be retrieved from a first domain based on an optimization target (e.g., minimizing latency, maximizing throughput, reducing energy consumption, a product performance goal, etc.) for a computing system. The first domain may include, but is not limited to, a computing infrastructure, an enterprise domain, a back-end system, a network domain, and/or the like. The policy framework may define operations associated with the computing system. The dataset may include but is not limited to historical/current operational parameters/constraints, hardware configurations and usage patterns, software configurations and usage patterns, device or product performance histories, third-party data, and/or the like. The dataset may be used to generate a model (e.g., a simulation model, a computational model, an analytical model, a digital prototype, etc.) for the policy framework that is executed in a second domain. The second domain may include, but is not limited to, a computational domain, a test domain, a simulation space, a non-production environment, and similar environments. The model for the policy framework may be executed within the second domain according to an operational data element associated with the policy framework. The operational data element may correspond to the optimization target. A recommended adjustment to the operational data element may be generated based on an error associated with the optimization target identified during execution of the model. An instruction that facilitates the recommended adjustment to the operational data element may be sent to the first domain.

### BRIEF DESCRIPTION OF THE DRAWINGS

The accompanying drawings are incorporated herein and form a part of the specification.

FIG. 1 is a block diagram of an example system for optimization of resources associated with a computing system, according to some aspects of this disclosure.

FIG. 2 is a flowchart of an example method for optimization of resources associated with a computing system, according to some aspects of this disclosure.

FIG. 3 is an example of a computer system useful for implementing various aspects of this disclosure.

In the drawings, like reference numbers generally indicate identical or similar elements. Additionally, generally, the leftmost digit(s) of a reference number identifies the drawing in which the reference number first appears.

### DETAILED DESCRIPTION

Provided herein are system, apparatus, device, method, and/or computer program product embodiments, and/or combinations and sub-combinations thereof, for the optimization of resources associated with a computing system. The computing system may support a variety of environments including, but not limited to, a computing environment (e.g., one or more computers along with supporting hardware, software, and network components operating collectively or independently, etc.), an enterprise environment (e.g., an entity infrastructure that includes or supports various technological devices, storage systems, operational procedures, digital products, production/development systems, content items, etc.), and/or the like. The system apparatus, device, method and/or computer program product embodiments, and/or combinations and sub-combinations thereof, for optimization of resources associated with a computing system, described herein, enable the selection, simulation, and adjustment of policy frameworks governing computing systems, allowing users to enhance performance, reduce inefficiencies, and optimize resource usage in both technical and business contexts.

According to some aspects of this disclosure, a user may utilize a user interface to select a policy framework from a plurality of policy frameworks. Each policy framework may define one or more operations associated with a computing system. For example, policy frameworks may define resource allocation and management operations, access control and security-based operations, data processing and workload management operations, network traffic and related operations, system health and anomaly detection operations, enterprise/business rules and operations, user and risk management operations, compliance and regulatory policy enforcement operations, supply chain and inventory management operations, user/customer relation operations, workforce management operations, and/or the like. In some examples, the policy framework may additionally or alternatively define one or more data elements, parameters, etc. associated with or related to the one or more operations.

A dataset corresponding to the selected policy framework may be used to generate a model (e.g., a simulation model, a computational model, a virtualization model, etc.) based on this dataset. For example, a predictive model may use the dataset corresponding to the selected policy framework to generate and output the model. According to certain aspects of this disclosure, the predictive model may be pre-trained to generate a model for any policy framework based on historical operational data for policy frameworks, enabling the predictive model to forecast the effects of changes to data elements. An execution of the model may be performed using operational data elements that are associated with an optimization target (e.g., an adjustment in processing speed, memory utilization, response time, cost reduction, item or product assessment, security protocol compliance, etc.) for the selected policy framework.

For example, in a scenario where an optimization target is to upgrade hardware associated with a policy framework, a model of the policy framework may be generated, and operational data elements indicative of upgradable hardware components (e.g., central processing unit (CPU), random access memory (RAM), storage drives (e.g., hard disk drive (HDD, solid-state drive (SSD), etc.), graphics card (GPU), power supply unit (PSU), etc.) may be manipulated during a simulation/virtualization of the model. Any errors or inconsistencies resulting from changes and/or implementation of operational data elements indicative of upgradable hardware components may be identified during simulation/virtualization of the model, and instructions for resolving the errors or inconsistencies may be generated.

In another scenario, where an optimization target is to adjust pricing or procedure associated with a consumer product associated with a policy framework supporting an enterprise endeavor (e.g., a line of business, etc.), a model of the policy framework may be generated and operational data elements indicative of the pricing or procedure may be manipulated during a simulation/virtualization of the model. Any errors or inconsistencies resulting from changes and/or implementation of operational data elements indicative of the pricing or procedure may be identified during simulation/virtualization of the model, and instructions for resolving the errors or inconsistencies may be generated. Again, these are just example scenarios of for optimization of resources associated with a computing system. However, a person of ordinary skill in the art understands that there may be many applicable scenarios.

The system, apparatus, device, method and/or computer program product embodiments, and/or combinations and sub-combinations thereof, for optimization of resources associated with a computing system improve at least the technological fields of system management, computer science, and digital commerce by introducing a dynamic, and predictive approach to optimization of computing systems, enterprise systems, and/or the like. Notably, conventional systems typically rely on predefined configurations and manual tuning, where administrators must manually analyze system performance, adjust policies based on historical data, and iteratively test changes in live environments—a process that is error-prone and resource-intensive. Furthermore, conventional optimization systems lack real-time adaptability, often resulting in the over-provisioning of resources, performance bottlenecks, security vulnerabilities, and inefficient computing operations. In contrast, The system, apparatus, device, method and/or computer program product embodiments, and/or combinations and sub-combinations thereof, for optimization of resources associated with a computing system, as described herein, enable optimization testing in a controlled environment to provide an understanding of how changes to policy frameworks impact system performance before implementation.

The use of custom simulations, as described herein, to identify inefficiencies or errors in optimization targets in real time at least enable reductions in computing system downtimes, prevents technically (and/or economically) unfavorable configurations that may impact the operation or implementation of a computer/computing system (and/or product for a given line of business), and may optimize resource allocation. The system, apparatus, device, method and/or computer program product embodiments, and/or combinations and sub-combinations thereof, as described herein, recommend and implement adjustments to operational data elements associated with a policy framework so that computing systems may continuously be optimized without requiring manual intervention, improving scalability, performance efficiency, and cost-effectiveness of any computing system supporting diverse industries. These and other technological advantages are described herein.

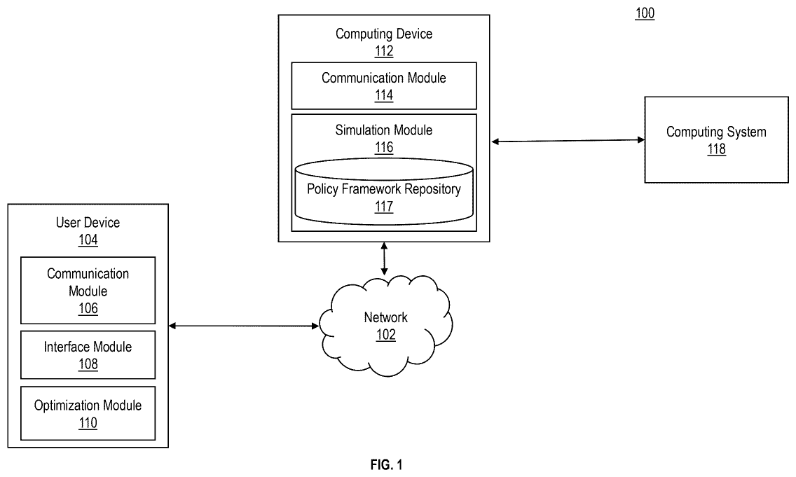

FIG. 1 shows a block diagram of an example system 100 for optimization of resources associated with a computing system. System 100 enables the retrieval, analysis, and optimization of policy frameworks governing computing resources. System 100 comprises multiple interconnected components that facilitate communication, simulate changes to policy frameworks, and refine the computing system based on the simulation. System 100 is merely an example of one suitable system environment and is not intended to suggest any limitation as to the scope of use or functionality of aspects described herein. Neither should system 100 be interpreted as having any dependency or requirement related to any single device/module/component or combination of devices/modules/components described therein.

According to some aspects of this disclosure, system 100 may include a network 102. According to some aspects of this disclosure, network 102 may comprise a packet-switched network (e.g., an Internet Protocol-based network), a non-packet-switched network (e.g., a quadrature amplitude modulation-based network), and/or the like. According to some aspects of this disclosure, network 102 may include network adapters, switches, routers, modems, and the like connected through wireless links (e.g., radiofrequency, satellite) and/or physical links (e.g., fiber optic cable, coaxial cable, Ethernet cable, or a combination thereof). Network 102 may include public networks, private networks, wide-area networks (e.g., the Internet), local-area networks, and/or similar networks. According to some aspects of this disclosure, network 102 may provide and/or support communication from various electronic devices, including servers, computers, telephones, cellular phones, modems, and other devices, to and throughout system 100. For example, system 100 may include and support communications between user device 104, computing device 112, and computing system 118 via network 102.

According to some aspects of this disclosure, user device 104 may include, for example, a smart device, a mobile device, a laptop, a tablet, a display device, a computing device, a server, or any other device capable of communicating with computing device 112, computing system 118, and/or any other device/component of system 100, either shown or not shown.

According to some aspects of this disclosure, user device 104 may include communication module 106 that facilitates and/or enables communication with network 102 (e.g., devices, components, and/or systems of network 102, etc.), computing device 112, and/or any other device/component of system 100. For example, communication module 106 may include hardware and/or software to facilitate communication. According to some aspects of this disclosure, communication module 106 may include one or more of a modem, transceiver (e.g., wireless transceiver, wired transceiver, etc.), digital-to-analog converter, analog-to-digital converter, encoder, decoder, modulator, demodulator, tuner (e.g., quadrature amplitude modulation (QAM) tuner, quadrature phase shift keying (QPSK) tuner, etc.), and/or the like. According to some aspects of this disclosure, communication module 106 may include any hardware and/or software necessary to facilitate communication.

According to some aspects of this disclosure, user device 104 may include interface module 108. Interface module 108 may enable users to interact with device 104, network 102, computing device 112, computing system 118, and/or any other device/component of system 100. According to some aspects of this disclosure, interface module 108 may include one or more input devices and/or components, for example, a keyboard, a pointing device (e.g., a computer mouse, remote control), a microphone, a joystick, a tactile input device (e.g., touch screen, gloves, etc.), and/or the like. Interaction with the input devices and/or components may enable a user to interact with a user interface generated and/or displayed by user device 104 and/or the like.

According to some aspects of this disclosure, user device 104 may include optimization module 110. Optimization module 110 may include software, such as an application and/or the like configured on user device 104. Optimization module 110 may include any interface for presenting and/or receiving information. For example, optimization module 110 may include a user interface, a command-line interface, and/or the like that may be used to select policy frameworks, configure simulations, review optimization results, and implement optimization recommendations.

For example, a user interface associated with optimization module 110 may be used to select one or more policy frameworks based on an optimization target. Policy frameworks may define operations for various devices, components, portions, and/or the like associated with computing system 118. According to some aspects of this disclosure, policy frameworks may include, but are not limited to, any set of rules, configurations, and/or operational parameters that dictate/govern the behavior of one or more system components (e.g., access control policies, memory/computing resource allocation policies, throughput, firewall configurations, etc.). In some scenarios, such as where computing system 118 is an enterprise system, policy frameworks include the structure, rules, and parameters that define an insurance product (e.g., coverage limits, premiums, deductibles, eligibility criteria, base rates, etc.).

According to some aspects of this disclosure, computing system 118 may include an integrated set of hardware and software components that exchange data/information, process data/information, manage/support items (e.g., tangible items, digital items, etc.), store data/information, and/or the like. Computing system 118 may include any environment where policy frameworks may be implemented and manipulated to optimize the performance of computing system 118 and its associated items or components.

An optimization target may include any performance goal (e.g., a device operational performance goal, a computing system performance goal, an item or product behavior goal, etc.), efficiency metric, or operational improvement objective associated with a computing system, an enterprise environment, or similar contexts. For instance, an optimization target may include any performance goal, efficiency metric, or operational improvement objective for any device, component, portion, operation, or the like associated with computing system 118.

Optimization targets for computing system 118 may include, but are not limited to, manipulation of a policy frameworks to: reduce computational resource waste by ensuring CPU, memory, and storage allocation is dynamically adjusted (e.g., via manipulation of a policy framework, etc.) based on actual usage patterns; minimize latency between devices/components of computing system 118 by optimizing firewall rules or data routing policies; maximize data/transaction throughput within computing system 118 by adjusting load balancing configurations; enhancing security via protocol versioning, encryption schemes, access control policies, and/or the like.

Optimization targets may vary based on the type of computing system and its operational needs. Optimization targets may change based on factors that include, but are not limited to, real-time system or market conditions, system or entity objectives, pre-production analysis for items, user-defined preferences, and/or the like. For example, in a scenario where computing system 118 represents an enterprise system, optimization targets for computing system 118 may include, but are not limited to, manipulation of a policy frameworks to: predict item value and/or pricing by adjusting associated policy parameters (e.g., deductible amounts, coverage limits, user inclusions, user exclusions, etc.).

According to some aspects of this disclosure, an interaction with one or more input devices of interface module 108 may be used to select a policy framework presented via optimization module 110 based on an optimization target. As described in greater detail later herein, an indication of the selected policy framework may be sent to computing device 112, and computing device 112 may use a dataset (e.g., stored via policy framework repository 117, etc.) corresponding to the selected policy framework to generate a model (e.g., a simulation model, a computational model, a virtualization model, etc.) for the selected policy framework.

According to some aspects of this disclosure, computing device 112 may include a server, a cloud-based computing resource, or any other device capable of communicating with user device 104, computing system 118, and/or any other device/component of system 100. Although depicted as a single device, according to some aspects of this disclosure, computing device 112 may be part of a computing system and/or infrastructure, or may represent a plurality of computing devices. For example, computing device 112 may represent a plurality of computing devices in communication with user device 104, computing system 118, and/or any other device/component of system 100.

According to some aspects of this disclosure, computing device 112 may include communication module 114 that facilitates and/or enables communication with network 102 (e.g., devices, components, and/or systems of network 102, etc.), user device 104, computing system 118, and/or any other device/component of system 100. For example, communication module 114 may include hardware and/or software to facilitate communication. According to some aspects of this disclosure, communication module 114 may include one or more of a modem, transceiver (e.g., wireless transceiver, wired transceiver, etc.), digital-to-analog converter, analog-to-digital converter, encoder, decoder, modulator, demodulator, tuner (e.g., QAM tuner, QPSK tuner, etc.), and/or the like. According to some aspects of this disclosure, communication module 114 may include any hardware and/or software necessary to facilitate communication.

According to some aspects of this disclosure, computing device 112 may include a simulation module 116. Simulation module 116 may include software, such as an application and/or the like configured with computing device 112. Simulation module 116 may be a component of an application architecture (e.g., a client-server model) that enables optimization module 110 of user device 104 to communicate with computing device 112. Simulation module 116 and optimization module 110 may be separate domains within an application. According to some aspects of this disclosure, the optimization module 110 may include an application programming interface (API) specifically designed to communicate with the simulation module 116.

According to some aspects of this disclosure, simulation module 116 may operate as an intermediary to facilitate the exchange of information (e.g., via API calls, etc.) between optimization module 110 of user device 104 and computing system 118. Simulation module 116 may request or query various files from a local source (e.g., policy framework repository 117, etc.) and a remote source, such as user device 104, computing system 118, and any other device/component of system 100. For example, when policy frameworks associated with computing system 118 are selected according to optimization targets, simulation module 116 may generate models for the policy frameworks based on corresponding datasets for the policy frameworks. Simulation module 116 may retrieve datasets for policy frameworks from policy framework repository 117, which may include, but is not limited to, rules, configurations, operational parameters, and/or the like that dictate the behavior of computing system 118.

According to some aspects of this disclosure, simulation module 116 may preprocess datasets for policy frameworks, where missing values are handled, outliers are detected, and the dataset is structured into a form suitable for modeling. For example, a raw dataset for a policy framework that includes CPU utilization logs might be normalized to ensure consistency across different computing environments. In another scenario, a policy framework may include entity data, such as insurance claim amounts, that may be categorized into risk brackets before being used to generate a model.

According to some aspects of this disclosure, simulation module 116 may generate a model (e.g., a simulation model, a computational model, an analytical model, a digital prototype, etc.) that reflects how changes to one or more parameters of a policy framework might impact performance of computing system 118. The model may employ machine learning algorithms, statistical analysis, or rule-based logic to predict the outcomes of different configurations based on any operational data element (e.g., under various operational conditions, etc.). For example, simulation module 116 may generate a rule-based model (e.g., for deterministic policy evaluations, such as firewall access control policies, etc.), a statistical model (e.g., for probability-based optimizations, such as estimating the likelihood of a network bottleneck, etc.), a machine-learning-based model (e.g., for complex, pattern-driven optimizations, such as fraud or risk detection in insurance claims, etc.). For example, in a cloud computing environment, simulation module 116 may utilize a predictive regression model to estimate CPU load under different scaling policies. In contrast, an insurance context, simulation module 116 may use a neural network to predict the probability of a high-risk claim payout based on policyholder data and/or the like.

According to some aspects of this disclosure, simulation module 116 may generate a model (e.g., a simulation model, a computational model, an analytical model, a digital prototype, etc.) that reflects how changes to parameters of a policy framework impact computing system 18 by inputting a dataset for a policy framework into a predictive model. The predictive model may be trained on historical operational data for policy frameworks to forecast effects of changes to data elements. Conventional methods of machine-learning model (e.g., predictive model, etc.) training suffer from several technical limitations that are resolved by the two-stage training process described herein.

Conventional methods of training a machine-learning model (e.g., predictive model, etc.) rely on static rule-based configurations and/or manually tuned parameters, which fail to adapt dynamically to changing conditions. As a result, computing systems, such as computing system 118 that depend on conventionally trained machine-learning models for analysis may experience inefficient resource allocation, policy misconfigurations, or security vulnerabilities, which may lead to suboptimal performance.

In the context of policy frameworks, conventional methods of machine-learning model (e.g., predictive model, etc.) training and generation often struggle with inaccurate generalization, particularly when applied to complex and evolving operational environments. For example, a machine-learning model (e.g., a predictive model, etc.) trained on a limited dataset of cloud resource allocation policies may fail to accurately predict performance bottlenecks when applied to a different computing system workload pattern. Similarly, a conventionally trained machine-learning model used to generate a model for a policy framework associated with an enterprise system supporting insurance products and/or the like are routinely trained on a small dataset and may thus overfit to past claim trends and fail to adapt to emerging factors affecting an insurance product. These limitations arise due to insufficient training data, lack of adaptability, and an inability to correct misclassifications or suboptimal recommendations in an iterative manner.

In contrast, as described herein, simulation module 116 may use a two-stage training process to enhance the accuracy and adaptability of predictive models used for optimization of resources associated with a computing system. For example, during predictive model training, simulation module 116 may use an expanded training dataset to enhance the ability of its predictive models to generalize across different operational scenarios. The expanded dataset may be generated by applying data transformation techniques to an initial dataset of policy framework data. These transformations may include, but are not limited to, simulated variations in system load, different security threat scenarios, adjusted policy constraints, altered entity product conditions, and/or the like. For example, transformations may include varying CPU demand patterns, adjusting network traffic loads, modifying access control settings, and/or the like. For a model used to support an enterprise system and/or the like, transformations may include simulating different risk scenarios, altering deductible amounts, and/or any other relevant data variations. By exposing the predictive model to a broader range of policy framework and/or computing system conditions, simulation module 116 may generate a predictive model that is robust and adaptable. However, training the predictive model with an expanded dataset may lead to increased misclassification or inaccurate predictions in certain outlier and/or edge scenarios. As a technical solution to this issue, simulation module 116 may incorporate a second stage of iterative training, where a predictive model is refined based on real-world failed or inaccurate predictions.

After the initial training of its predictive models, simulation module 116 may identify and/or determine any incorrectly classified recommendations for adjustments to the operational data elements. Simulation module 116 may add these misclassifications to an updated training set, along with the original expanded dataset, and predictive models of simulation module 116 may be retrained during a second iteration. This iterative approach to predictive model training used by simulation module 116 improves accuracy when optimizing resources associated with computing system 118 by ensuring that predictive models of simulation module 116 may learn from past mistakes in generating models (e.g., simulation models, computational models, analytical models, digital prototypes, etc.) for policy frameworks by adapting to previously unaccounted-for variations.

The combination of expanded training data and iterative refinement used by simulation module 116 to prepare its predictive models may be summarized as simulation module 116 first collecting a first dataset of policy framework data from a database, where the policy framework defines an operation associated with the computing system. Simulation module 116 may then apply one or more transformations to the first dataset of policy framework data. Transformations applied may include, but are not limited to, simulated workload variations, adjusted policy constraints, altered security configurations, and/or the like. Simulation module 116 may generate a modified dataset of policy framework data.

Simulation module 116 may generate/create a first training set that includes the collected first dataset, the modified dataset, and additional external data representing real-world operational conditions for a computing system (e.g., computing system 118, etc.). Simulation module 116 may train the predictive model in a first stage using the first training set to generate an initial model for a policy framework. Simulation module 116 may determine and/or identify any misclassifications or inefficiencies in the generated model for the policy framework based on operational validation data. Simulation module 116 may generate/create a second training set comprising the first training set and additional policy framework data corresponding to any identified misclassifications or inefficiencies in the generated model for the policy framework. Simulation module 116 may train the predictive model in a second stage using the second training set to refine and improve the accuracy of the predictive model in generating models (e.g., simulation models, computational models, analytical models, digital prototypes, etc.) for policy frameworks.

Simulation module 116, for example, a trained predictive model of simulation module 116, may generate a model for a policy framework based on a dataset for the policy framework according to an optimization target. For example, simulation module 116 may extract key features from preprocessed datasets that influence policy framework and/or performance of an associated computing system (e.g., computing system 118, etc.). Feature selection may be based on relevance to the optimization target. For example, in a scenario where computing system 118 is a cloud computing system, simulation module 116 may extract features associated with and/or indicative of CPU load, memory utilization, disk I/O, latency, and/or the like. In another scenario, such as where computing system 118 is an enterprise system supporting insurance products, simulation module 116 may extract features associated with and/or indicative of policyholder demographics, claim history data, deductible amounts, geographic risk factors, and/or the like. Simulation module 116 may use determined, identified, and/or extracted key features to generate a model for a policy framework via an appropriate modeling technique.

According to some aspects of this disclosure, once a model (e.g., a simulation model, a computational model, an analytical model, a digital prototype, etc.) for a policy framework has been generated and/or defined, simulation module 116 may execute a model by executing simulations under different conditions. Executing simulations under different conditions enables simulation module 116 to determine how changes in operational data elements associated with policy frameworks impact real-time system performance. When an execution (e.g., simulation, etc.) of a model is complete, simulation module 116 may evaluate any discrepancies between expected (e.g., based on an optimization target, etc.) and actual results, identify any errors or inefficiencies, and generate recommendations for optimizing resources associated with a computing system.

According to some aspects of this disclosure, simulation module 116 may support and/or enable prioritized and/or parallel generation and execution of models (e.g., simulation models, computational models, analytical models, digital prototypes, etc.) for policy frameworks based on different optimization targets. Given that different models generated for different policy frameworks (e.g., policy frameworks that define the operations associated with the same or different computing systems, etc.) may have varying computational requirements, dependencies, and execution priorities, simulation module 116 may use different queuing mechanisms to ensure that computational resources of computing device 112 are allocated effectively. Simulation module 116 may use different queuing techniques to efficiently manage the parallel generation and execution of models for policy frameworks based on different optimization targets. For example, by implementing queuing techniques that include, but are not limited to, priority queues, round-robin scheduling, batch processing, and/or the like, simulation module 116 may optimizes the scheduling and execution of multiple models (e.g., simulation models, computational models, analytical models, digital prototypes, etc.) for policy frameworks.

For example, simulation module 116 may use priority-based queuing to assign execution priority to different models for policy frameworks based on predefined criteria that includes, but is not limited to, optimization target importance, computational intensity, deadline constraints, and/or the like. For example, in a scenario where computing system 118 is a cloud computing system, a model generated based on an optimization target of preventing system downtime due to resource exhaustion may be assigned a higher priority than a model generated based on a optimization target to fine-tune memory/storage allocations and/or services since availability may be deemed more critical in memory/storage operations. In a scenario where computing system 118 is an enterprise system, a model generated based on an optimization target of forecasting/predicting a base rate for an insurance product may be prioritized over a model generated for evaluating pricing strategies since failures in base rate predictions may cause a greater disruption to a target line of business. Priority-based simulation module 116 may use priority-based queuing to enable the most critical models to be generated and executed first while less urgent models may be processed in the background without stalling the system.

According to some aspects of this disclosure, simulation module 116 may use a round-robin technique for the generation and execution of models (e.g., simulation models, computational models, analytical models, digital prototypes, etc.) for policy frameworks based on different optimization targets. Simulation module 116 may use round-robin queuing to distribute processing power of computing device 112 evenly for each generated model. Simulation module 116 may use round-robin queuing to balances resource allocation across generation and execution of models in scenarios where no single model should take precedence over others given their respective optimization targets.

According to some aspects of this disclosure, for large-scale generations and executions of models (e.g., simulation models, computational models, analytical models, digital prototypes, etc.) for policy frameworks based on different optimization targets that include extensive datasets and long execution times, simulation module 116 may use batch processing queuing techniques. For example, simulation module 116 may group similar models together and execute them in predefined batches to reduce overhead (e.g., excess software or hardware use, duplicate data, etc.) and improve computational efficiency of at least computing device 112. In a scenario where computing system 118 is an enterprise system, for a model generated to serve as a risk assessment model (e.g., based on an optimization target, etc.), different model executions may be grouped based on similar risk categories. By executing models in batches, simulation module 116 may minimize overhead caused by context-switching and may enable computational resources (e.g., memory, processing power, storage, etc.) of computing device 112 and/or computing system 118 to be optimally utilized. According to some aspects of this disclosure, simulation module 116 may support any queuing technique and/or scheme for the generation and execution of models (e.g., simulation models, computational models, analytical models, digital prototypes, etc.) for policy frameworks based on different optimization targets.

According to some aspects of this disclosure, simulation module 116 may support and/or enable parallel generation and execution of models for policy frameworks based on different optimization targets. Simulation module 116 may support and/or enable parallel generation and execution of models to improve the decision-making speed and accuracy for any optimization target, allowing any errors, inefficiencies and/or the like for resources associated with computing system 118 to be identified and resolved in a manner that is faster and more accurate than conventional methods of resource optimization. Parallel generation and execution of models for policy frameworks enables users to explore different optimization targets simultaneously, rather than sequentially, to avoid performance bottlenecks, scalability issues, technical problems due to resource utilization, and/or the like. Parallel generation and execution of models for policy frameworks enables system 100 to mitigate the impact of single failures during model generation and execution, while also reducing the overall processing time for the generation and execution of models by distributing the workload across multiple queues and processing units of computing device 112.

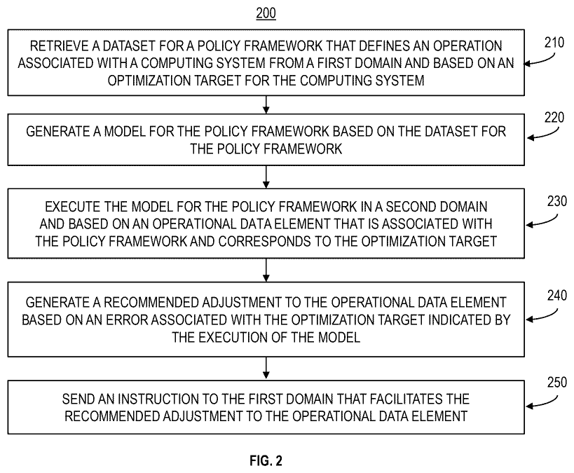

FIG. 2 is a flowchart for an example method 200 for optimization of resources associated with a computing system, according to aspects of this disclosure. Method 200 may be performed by processing logic that may comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously or in a different order than shown in FIG. 2, as will be understood by a person of ordinary skill in the art.

Method 200 shall be described with reference to FIG. 1. However, method 200 is not limited to those figures or related aspects.

In 210, computing device 112 may retrieve a dataset for a policy framework of a plurality of policy frameworks from a first domain. According to some aspects of this disclosure, computing device 112 may retrieve the dataset for the policy framework based on receiving an indication of a selection of a user interface (e.g., a user interface of user device 104, etc.) selection element associated with the policy framework. Computing device 112 may retrieve the dataset for the policy framework from the first domain via a secure API.

The first domain may include, but is not limited to, an enterprise domain, a private domain, a back-end system, a network domain, and/or the like. The policy framework may be selected from the plurality of policy frameworks based on an optimization target for a computing system, such as computing system 118. The policy framework may define operations associated with computing system 118. According to some aspects of this disclosure, a dataset for a policy framework may include, but is not limited to, data/information indicative of and/or associated with any rules, configurations, operational parameters, and/or the like that dictate/govern the behavior of one or more system components (e.g., device settings, access control policies, memory/computing resource allocation policies, throughput, firewall configurations, etc.). The dataset for the policy framework may include and/or represent structured information that defines how computing system 118 operates, optimizes resources, enforces rules, and/or the like. According to some aspects of this disclosure, the contents of the dataset may vary depending on the implementation of computing system 118.

According to some aspects of this disclosure, the dataset for the policy framework may include data/information indicative of and/or associated with user roles, authentication methods, access logs, encryption settings, firewall rules, device configurations, CPU/memory limits, storage quotas, auto-scaling parameters, workload priority settings, network bandwidth allocation, congestion thresholds, routing configurations, service-level agreements (SLAs), system health logs, automatic failover triggers, backup schedules, incident response times, and/or the like. In a scenario where computing system 118 is an enterprise system (e.g., supporting insurance products, etc.) the dataset for the policy framework may include data/information indicative of and/or associated with customer insurance policies, product pricing, base rate calculations, coverage limits, claim approval criteria, fraud detection thresholds, customer demographics, historical production data, user/customer segmentation models, revenue forecasting, discounting rules, and/or the like. In some scenarios, such as where computing system 118 is an enterprise system, a dataset for a policy framework may include, but is not limited to, data/information indicative of and/or associated with any structure, rules, parameters, and/or the like that define an insurance product (e.g., coverage limits, premiums, deductibles, eligibility criteria, etc.).

In 220, computing device 112 may generate a model (e.g., a simulation model, a computational model, an analytical model, a digital prototype, etc.) for the policy framework based on the dataset for the policy framework. When the dataset for the policy framework dataset is retrieved, computing device 112 may construct a model representing the structure and dependencies of the policy framework.

According to some aspects of this disclosure, computing device 112 may generate the model for the policy framework by inputting the dataset into a predictive model trained on historical operational data for policy frameworks to forecast the effects of changes to data elements. Computing device 112 may receive the predictive model as an output of the predictive model. According to some aspects of this disclosure, computing device 112 may incorporate machine learning techniques, statistical analysis, rule-based processing, and/or the like to simulate configurations, changes, and/or scenarios associated with the operational data element.

In 230, computing device 112 may execute the model for the policy framework. Computing device 112 may execute the model for the policy framework in a second domain and based on an operational data element associated with the policy framework.

According to some aspects of this disclosure, execution of the model may include applying the model to actual performance metrics associated with the optimization target (e.g., CPU usage logs, network latency reports, application response times, pricing, base rates, etc.) to evaluate potential outcomes under various conditions. In an enterprise context for a given domain, such as an insurance product or offering, the execution of the model may involve applying modifications to product data (e.g., insurance policy data, vendor data) to test whether adjusting the operational data element achieves a specified base rate for an insurance product. These are merely examples of the model's execution, and other scenarios are also contemplated herein.

According to some aspects of this disclosure, the second domain may be a testing and/or simulation/virtualization domain for modeling policy frameworks is a controlled environment. The second domain enables experimentation, analysis, and/or evaluation of different policy framework variations and computing system conditions without impacting live operations. According to some aspects of this disclosure, the operational data element associated with the policy framework may correspond to and/or be associated with the optimization target.

According to some aspects of this disclosure, the operational data element associated with the policy framework may include a new data element that is associated with an operational component of the policy framework, or may be a change to a current data element that is associated with the operational component of the policy framework, and/or the like.

For example, according to some aspects of this disclosure, the operational data element associated with the policy framework may include one or more sets of data elements that are to be added to the dataset for the policy framework. In some instances, the one or more sets of data elements that are to be added to the dataset for the policy framework may be used to override all data elements associated with the dataset for the policy framework.

In some instances, one or more sets of data elements (e.g., the operational data element) may be added to the dataset for the policy framework to override (e.g., change a value, etc.) and/or filter out (e.g., remove values to reduce the amount of data elements in the dataset) select data elements associated with the dataset for the policy framework and/or corresponding data elements for respective data sets for each policy framework of the plurality of policy frameworks.

In some instances, one or more sets of data elements (e.g., the operational data element) may be added to the dataset for the policy framework to override select portions of the data elements associated with the dataset for the policy framework. For example, a new data element may be used to change a value of a data element representing a targeted characteristic of the policy framework based on conditions and criteria that may be specified via the user interface (e.g., the user interface of user device 104, etc.).

As the model executes, computing device 112 may monitor deviations between expected results (e.g., expected based on the optimization target) and actual results to detect inefficiencies, errors, product or policy violations, and/or similar issues. For example, this may include identifying bottlenecks in data throughput, excessive resource consumption, or misconfigured security policies associated with computing system 118. For instance, in an enterprise context for a given domain, such as an insurance product or offering, if an operational target is set for a base rate associated with the insurance product or offering, and if an adjustment to an operational data element (e.g., a data element, parameter, rule, etc.) associated with the product or offering results in an unexpected base rate, computing device 112 may identify the occurrence as a discrepancy or error in satisfying the optimization target.

In 240, computing device 112 may generate a recommended adjustment to the operational data element. Computing device 112 may generate a recommended adjustment to the operational data element (or another operational data element) based on an error associated with the optimization target that results from executing the model. For example, computing device 112 may generate a recommended action to adjust the operational data element (or another operational data element) for (or associated with) a rule, a configuration, and/or operational parameter(s) that dictate/govern the behavior of one or more components of computing system 118. In a scenario where computing system 118 is an enterprise system, computing device 112 may generate a recommend action to adjust the operational data element (or another operational data element) for (or associated with) a rule (e.g., an underwriting rule, etc.) or configuration for an insurance product (or offering) in a manner that is likely to achieve the operational target. These are merely some examples, and other examples are contemplated herein. Computing device 112 may generate a recommended action to adjust any operational data element to satisfy the optimization target.

In 250, computing device 112 may send, to the first domain, an instruction that facilitates the recommended adjustment to the operational data element (or other operational data element). In a scenario where computing system 118 is an enterprise system and the selected policy framework is associated with an insurance product, computing device 112 may send an instruction to the first domain. The instruction may notify a user (e.g., an underwriter, etc.) to review and approve suggested policy framework modifications, such as adjusting premium tiers, revising claim eligibility requirements, and similar changes.

According to some aspects of this disclosure, computing device 112 may send (e.g., to the first domain) an instruction that facilitates the recommended adjustment to the operational data element based on an interaction with an interactive element of the user interface (step 210). For example, computing device 112 may cause user device 104 to display a notification or other indication of the recommended adjustment to the operational data element. An interaction with the user interface may be used to accept the recommended adjustment to the operational element, and computing device 112 may send the instruction that facilitates the recommended adjustment to the operational data element based on the acceptance of the notification. According to some aspects of this disclosure, computing device 112 may send an instruction that facilitates the recommended adjustment to the operational data element based on an indication that the recommended adjustment is a preauthorized type of adjustment to the operational data element. For example, certain actions, such as specific types of adjustments to operational data elements, may be whitelisted and/or preapproved for automatic implementation by computing device 112.

According to some aspects of this disclosure, the instruction that facilitates the recommended adjustment to the operational data element causes effects including, but not limited to, an adjustment to an amount of resources allocated to the policy framework, a change to an operation (e.g., a rule, a data element, a parameter, etc.) of the policy framework, a change to a location of implementation of the policy framework (or a product associated with the policy framework, etc.).

According to some aspects of this disclosure, method 200 may further include computing device 112 generating an additional model for another policy framework based on a dataset for the other policy framework. In this scenario, computing device 112 executing the model for the policy framework in step 230 may also include executing the additional model for the other policy framework in the second domain and based on an operational data element associated with the other policy framework. The operational data element associated with the other policy framework may correspond to another optimization target. Computing device 112 may execute the model and the additional model in an order determined based on respective priority scores assigned to the optimization target and the other optimization target. According to some aspects of this disclosure, computing device 112 may execute the model and the additional model in parallel based on an indication that a sequential execution of the model and the additional model exceeds a computational resource utilization threshold. The computational resource utilization threshold may be associated with computational resources associated with computing device 112, computing system 118, and/or the like.

According to some aspects of this disclosure, computing device 112 may generate a recommended adjustment to the operational data element associated with the other policy framework based on an error associated with the other optimization target indicated by the execution of the additional model. Computing device 112 may an instruction to the first domain that facilitates the recommended adjustment to the operational data element associated with the other optimization target.

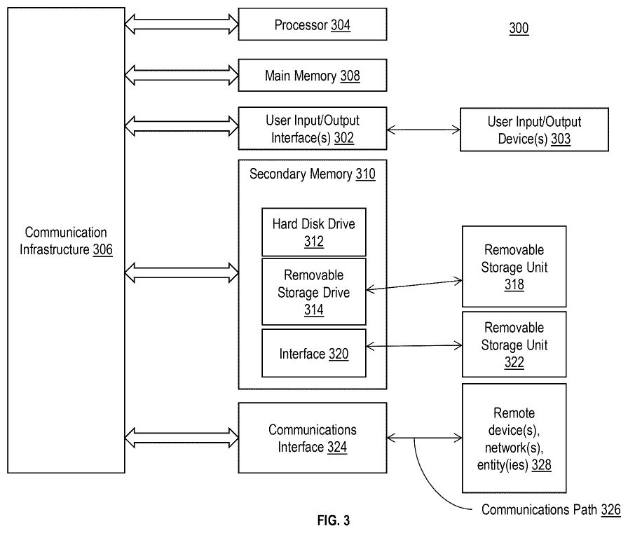

Various aspects of this disclosure may be implemented, for example, using one or more well-known computer systems, such as computer system 300 shown in FIG. 3. One or more computer systems 300 may be used, for example, to implement any of the aspects discussed herein, as well as combinations and sub-combinations thereof.

Computer system 300 may include one or more processors (also referred to as CPUs), such as one or more processors 304. One or more of processors 304 may be a GPU. According to some aspects of this disclosure, a GPU may be a specialized electronic circuit processor designed to process mathematically intensive applications. The GPU may have a parallel structure that is efficient for parallel processing of large blocks of data, such as mathematically intensive data common to computer graphics applications, images, videos, etc. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

Computer system 300 may also include a main or primary memory 308, such as RAM. Main memory 308 may include one or more levels of cache. Main memory 308 may have stored therein control logic (e.g., computer software) and/or data.

Computer system 300 may also include one or more secondary storage devices or memory 310. Secondary memory 310 may include, for example, a hard disk drive 312 and/or a removable storage drive 314. Removable storage drive 314 may be a floppy disk drive, a magnetic tape drive, a compact disk drive, an optical storage device, a tape backup device, and/or any other storage device/drive.

Removable storage drive 314 may interact with a removable storage unit 318. Removable storage unit 318 may include a computer-usable or readable storage device having stored thereon computer software (e.g., control logic, etc.) and/or data. Removable storage unit 318 may be a floppy disk, magnetic tape, compact disk, digital video disk (DVD), optical storage disk, and/or any other computer data storage device. Removable storage drive 314 may read from and/or write to removable storage unit 318.

Secondary memory 310 may include other means, devices, components, instrumentalities, or other approaches for allowing computer programs and/or other instructions and/or data to be accessed by computer system 300. Such means, devices, components, instrumentalities, or other approaches may include, for example, a removable storage unit 322 and an interface 320. Examples of the removable storage unit 322 and the interface 320 may include a program cartridge and cartridge interface (such as that found in video game devices), a removable memory chip (such as an programmable read-only memory (PROM) or erasable PROM (EPROM) and associated socket, a memory stick and universal serial bus (USB) port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof) and which may include any combination of local area networks (LANs), wide area networks (WANs), the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smartphone, smartwatch or other wearable, appliance, part of the Internet-of-Things (IoTs), and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (Saas), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

According to some aspects of this disclosure, a tangible, non-transitory apparatus or article of manufacture comprising a tangible, non-transitory computer useable or readable medium having control logic (e.g., software, etc.) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use various aspects of this disclosure using data processing devices, computer systems, and/or computer architectures other than that shown in FIG. 3. In particular, various aspects described herein may operate with software, hardware, and/or operating system implementations other than those described herein.

It is to be appreciated that the Detailed Description section, and not any other section, is intended to be used to interpret the claims. Other sections may set forth one or more but not all exemplary embodiments as contemplated by the inventor(s) and, thus, are not intended to limit this disclosure or the appended claims in any way.

While this disclosure describes exemplary embodiments for exemplary fields and applications, it should be understood that the disclosure is not limited thereto. Other aspects, examples, embodiments, and/or modifications thereto are possible and are within the scope and spirit of this disclosure. For example, and without limiting the generality of this paragraph, aspects, examples, and/or embodiments are not limited to the software, hardware, firmware, and/or entities illustrated in the figures and/or described herein. Further, embodiments (whether or not explicitly described herein) have significant utility to fields and applications beyond the examples described herein.

Various aspects have been described herein with the aid of functional building blocks illustrating the implementation of specified functions and relationships thereof. The boundaries of these functional building blocks have been arbitrarily defined herein for the convenience of the description. Alternate boundaries may be defined as long as the specified functions and relationships (or equivalents thereof) are appropriately performed. Also, alternative embodiments may perform functional blocks, steps, operations, methods, etc. using orderings different than those described herein.

References herein to “an aspect,” “an example,” “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments may be described using the expressions “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The breadth and scope of this disclosure should not be limited by any of the above-described exemplary embodiments, but should be defined only in accordance with the following claims and their equivalents.

What is claimed is:

1. A computer-implemented method for optimizing resources associated with a computing system, comprising:
retrieving, from a first domain and based on an optimization target for a computing system, a dataset for a policy framework of a plurality of policy frameworks, wherein the policy framework defines an operation associated with the computing system;
generating a model for the policy framework based on the dataset for the policy framework;
executing, in a second domain and based on an operational data element associated with the policy framework, the model for the policy framework, wherein the operational data element corresponds to the optimization target;
generating, based on an error associated with the optimization target indicated by the execution of the model, a recommended adjustment to the operational data element; and
sending, to the first domain, an instruction that facilitates the recommended adjustment to the operational data element.

2. The computer-implemented method of claim 1, wherein the operational data element associated with the policy framework is at least one of a new data element that is associated with an operational component of the policy framework or a change to a current data element that is associated with the operational component of the policy framework.

3. The computer-implemented method of claim 1, wherein generating the model for the policy framework further comprises:
inputting the dataset into a predictive model trained on historical operational data for policy frameworks to forecast effects of changes to data elements; and
receiving the generated model as an output of the predictive model.

4. The computer-implemented method of claim 1, wherein the instruction that facilitates the recommended adjustment to the operational data element causes at least one of: an adjustment to an amount of resources allocated to the policy framework, a change to an operation of the policy framework, or a change to a location of implementation of the policy framework.

5. The computer-implemented method of claim 1, wherein retrieving the policy framework is further based on an interaction with a selection element of a user interface that selects the policy framework from the plurality of policy frameworks.

6. The computer-implemented method of claim 1, wherein sending the instruction that facilitates the recommended adjustment to the operational data element is based on at least one of an interaction with an interactive element of a user interface, or an indication that the recommended adjustment to the operational data element is a preauthorized type of adjustment to the operational data element.

7. The computer-implemented method of claim 1, further comprising generating an additional model for another policy framework based on a dataset for the other policy framework, wherein the executing the model for the policy framework further comprises:
executing, in the second domain and based on an operational data element associated with the other policy framework, the additional model for the other policy framework, wherein the operational data element associated with the other policy framework corresponds to another optimization target,
wherein the model and the additional model are executed in at least one of: an order determined based on respective priority scores assigned to the optimization target and the other optimization target, or parallel based on an indication that a sequential execution of the model and the additional model exceeds a computational resource utilization threshold.

8. A system, comprising:
a memory; and
at least one processor coupled to the memory and configured to:
retrieve, from a first domain and based on an optimization target for a computing system, a dataset for a policy framework of a plurality of policy frameworks, wherein the policy framework defines an operation associated with the computing system;
generate a model for the policy framework based on the dataset for the policy framework;
execute, in a second domain and based on an operational data element associated with the policy framework, the model for the policy framework, wherein the operational data element corresponds to the optimization target;
generate, based on an error associated with the optimization target indicated by the execution of the model, a recommended adjustment to the operational data element; and
send, to the first domain, an instruction that facilitates the recommended adjustment to the operational data element.

9. The system of claim 8, wherein the operational data element associated with the policy framework is at least one of a new data element that is associated with an operational component of the policy framework or a change to a current data element that is associated with the operational component of the policy framework.

10. The system of claim 8, wherein to generate the model for the policy framework, the at least one processor is further configured to:
input the dataset into a predictive model trained on historical operational data for policy frameworks to forecast effects of changes to data elements; and
receive the generated model as an output of the predictive model.

11. The system of claim 8, wherein the instruction that facilitates the recommended adjustment to the operational data element causes at least one of: an adjustment to an amount of resources allocated to the policy framework, a change to an operation of the policy framework, or a change to a location of implementation of the policy framework.

12. The system of claim 8, wherein the policy framework is retrieved further based on an interaction with a selection element of a user interface that selects the policy framework from the plurality of policy frameworks.

13. The system of claim 8, wherein the instruction that facilitates the recommended adjustment to the operational data element is sent is based on at least one of an interaction with an interactive element of a user interface, or an indication that the recommended adjustment to the operational data element is a preauthorized type of adjustment to the operational data element.

14. The system of claim 8, wherein the at least one processor is further configured to generate an additional model for another policy framework based on a dataset for the other policy framework, wherein to execute the model for the policy framework the at least one processor is further configured to:
execute, in the second domain and based on operational data element associated with the other policy framework, the additional model for the other policy framework, wherein the operational data element associated with the other policy framework corresponds to another optimization target,
wherein the model and the additional model are executed in at least one of: an order determined based on respective priority scores assigned to the optimization target and the other optimization target, or parallel based on an indication that a sequential execution of the model and the additional model exceeds a computational resource utilization threshold.

15. A non-transitory computer-readable medium having instructions stored thereon that, when executed by at least one computing device, causes the at least one computing device to perform operations comprising:
retrieving, from a first domain and based on an optimization target for a computing system, a dataset for a policy framework of a plurality of policy frameworks, wherein the policy framework defines an operation associated with the computing system;
generating a model for the policy framework based on the dataset for the policy framework;
executing, in a second domain and based on an operational data element associated with the policy framework, the model for the policy framework, wherein the operational data element corresponds to the optimization target;
generating, based on an error associated with the optimization target indicated by the execution of the model, a recommended adjustment to the operational data element; and
sending, to the first domain, an instruction that facilitates the recommended adjustment to the operational data element.

16. The non-transitory computer-readable medium of claim 15, wherein the operational data element associated with the policy fraamework is at least one of a new data element that is associated with an operational component of the policy framework or a change to a current data element that is associated with the operational component of the policy framework.

17. The non-transitory computer-readable medium of claim 15, wherein generating the model for the policy framework further comprises:
inputting the dataset into a predictive model trained on historical operational data for policy frameworks to forecast effects of changes to data elements; and
receiving the generated model as an output of the predictive model.

18. The non-transitory computer-readable medium of claim 15, wherein the instruction that facilitates the recommended adjustment to the operational data element causes at least one of: an adjustment to an amount of resources allocated to the policy framework, a change to an operation of the policy framework, or a change to a location of implementation of the policy framework.

19. The non-transitory computer-readable medium of claim 15, wherein retrieving the policy framework is further based on an interaction with a selection element of a user interface that selects the policy framework from the plurality of policy frameworks.

20. The non-transitory computer-readable medium of claim 15, wherein sending the instruction that facilitates the recommended adjustment to the operational data element is based on at least one of an interaction with an interactive element of a user interface, or an indication that the recommended adjustment to the operational data element is a preauthorized type of adjustment to the operational data element.
